(19) United States
(12) Patent Application Publication
(10) Pub. No.: US 2006/0241538 A1
(43) Pub. Date: Oct. 26, 2006

(54) Portable massage device

(76) Inventor: Chiu Ku Chen, Taichung (TW)

Correspondence Address: CHARLES E. BAXLEY, ESQ., 90 JOHN STREET, THIRD FLOOR, NEW YORK, NY, 10038, US

(21) Appl. No.: 11/101,246

(22) Filed: Apr. 7, 2005

(51) Int. Cl. A61H 7/00

(52) U.S. Cl. 601/134; 601/28

(57) ABSTRACT

A massage device includes an upper deck having one or more recesses formed in the bottom, and a number of protrusions extended upwardly from the upper portion. A lower base member includes an upper portion partially engaged into either of the recesses of the upper deck, to support the upper deck relative to the lower base member at different inclination, for suitably massaging various portions of the users. An anchoring device may anchor the upper deck to the lower base member, and includes one or more grooves formed in the upper portion of the upper deck, and one or more swellings extended into each recess of the lower base member, to anchor the upper deck to the lower base member.

### BACKGROUND OF THE INVENTION

1. Field of the Invention

The present invention relates to a massage device, and more particularly to a portable massage device adjustable to different inclinations relative to the ground or the supporting surface for suitably massaging various portions of the users.

2. Description of the Prior Art

Typical massage devices comprise a number of projections or protrusions extended upwardly from a planar support, for massaging the feet of the users. Some of the projections or protrusions may be vibrated or moved upwardly and downwardly relative to the planar support, to massage the feet of the users.

For example, U.S. Design Pat. No. Des. 388,879 to Chang discloses one of the typical massage devices comprising a number of projections or protrusions extended upwardly from a planar support and extended from a back support, for massaging the feet and/or the back portion of the users. However, the planar support is normally stably supported on the ground or the supporting surfaces, but may not be adjusted to different inclinations relative to the ground or the supporting surface, such that the typical massage devices also may not be used to suitably massage different portions of the users.

U.S. Pat. No. 6,013,042 to Sakai discloses another typical massage devices comprising a number of projections or protrusions extended upwardly from two planar platforms that may be disposed or supported on different elevations for massaging the feet of the users. However, similarly, the platforms are also stably supported on the ground or the supporting surfaces, but may not be adjusted to different inclinations relative to the ground or the supporting surface, such that the typical massage devices also may not be used to suitably massage different portions of the users.

The present invention has arisen to mitigate and/or obviate the afore-described disadvantages of the conventional massage devices.

### SUMMARY OF THE INVENTION

The primary objective of the present invention is to provide a massage device adjustable to different inclinations relative to the ground or the supporting surface for suitably massaging various portions of the users.

The other objective of the present invention is to provide a massage device including a number of projections or protrusions of different sizes or volumes or areas, for suitably massaging various portions of the users.

In accordance with one aspect of the invention, there is provided a massage device comprising an upper deck including at least one recess formed in a bottom portion thereof, and including an upper portion having a plurality of protrusions extended upwardly therefrom, and a lower base member including an upper portion partially engaged into the recess of the upper deck, to support the upper deck relative to the lower base member at a selected inclination, for suitably massaging various portions of the users, such as the feet, the back portions, the abdominal portions, the head portions, the neck portions of the users or the like.

The protrusions of the upper deck include different volume. The upper deck includes at least one magnetic member disposed in the protrusions. The upper deck includes a first end having a handle provided therein. The upper deck includes a second end having a width greater than that of the first end thereof.

The massage device may further include one or more recesses formed in the bottom portion of the upper deck, to support the upper deck in different inclination relative to the ground or the supporting surface or the lower base member.

An anchoring device may further be provided for anchoring the upper deck to the lower base member. The anchoring device includes at least one groove formed in the upper portion of the upper deck, and at least one swelling extended into the recess of the lower base member, to anchor the upper deck to the lower base member.

The recess of the upper deck may be located in a middle portion of the upper deck, to allow the upper deck to be supported on the lower base member as a seesaw.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a massage device in accordance with the present invention;

FIG. 2 is a top plan view of the massage device;

FIG. 3 is a bottom plan view showing an upper deck of the massage device;

FIG. 4 is a perspective view showing a lower base member for the massage device;

FIG. 5 is a side plan view of the massage device; and

FIGS. 6, 7 are side plan views similar to FIG. 5, illustrating the operation of the massage device.

### DETAILED DESCRIPTION OF THE PREFERRED EMBODIMENT

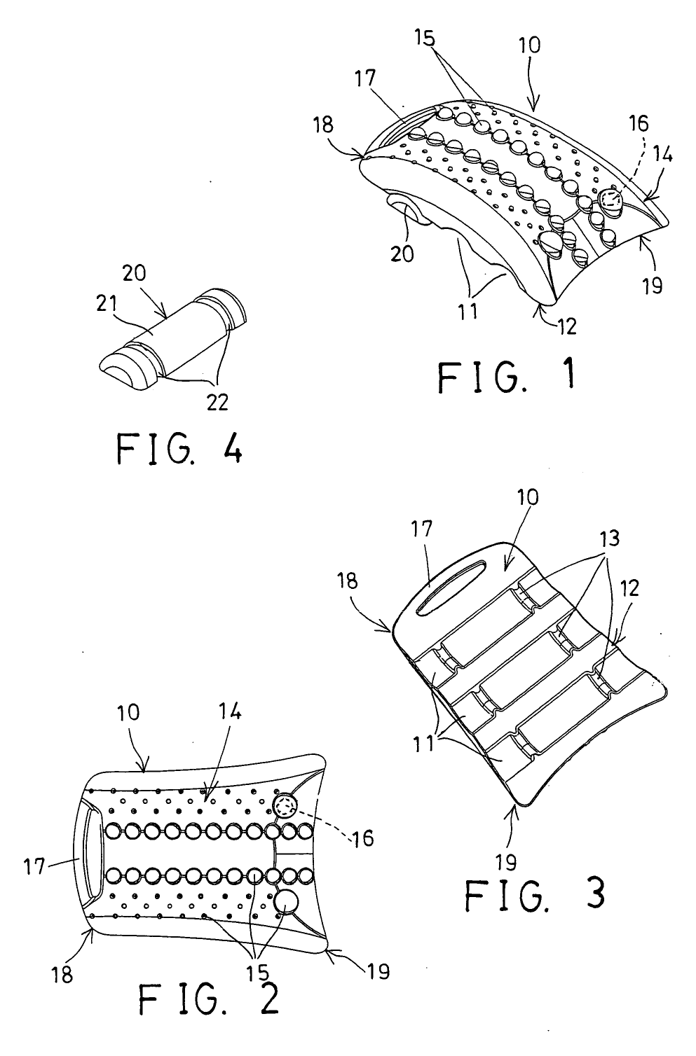

Referring to the drawings, and initially to FIGS. 1-5, a massage device in accordance with the present invention comprises an upper deck 10 including one or more recesses 11 laterally formed in a bottom portion 12 thereof, and preferably including one or more, such as two swellings 13 extended into each of the recesses 11 thereof and spaced away from each other.

The upper deck 10 further includes an upper surface or portion 14 having a number of projections or protrusions 15 extended upwardly therefrom. It is preferable that the protrusions 15 include different sizes or volumes or areas, for suitably massaging various portions of the users, such as the feet, the back portions, the abdominal portions, the head portions, the neck portions of the users or the like.

One of more of the protrusions 15 may further include one or more magnets or magnetic members 16 disposed or engaged therein, for facilitating the blood circulation of the users, for example. The upper deck 10 further includes a handle 17 formed or provided in one end portion 18, for carrying the upper deck 10, and preferably includes the other end portion 19 having a width greater than that of the one end portion 18 thereof, for further suitably massaging various portions of the users.

As shown in FIG. 2, the massage device further includes a lower base member 20 having an upper surface or portion 21, such as an upwardly curved upper portion 21 for partially engaging into the recesses 11 of the upper deck 10, and having one or more grooves 22 formed in the upper portion 21 thereof, for receiving the swellings 13 of the upper deck 10, and for anchoring or positioning the upper deck 10 on top of the lower base member 20.

For example, by engaging the swellings 13 of the upper deck 10 into the grooves 22 that are formed in the upper portion 21 of the lower base member 20, the upper deck 10 may be prevented from being moved laterally relative to the lower base member 20, and may thus be suitably anchored or positioned to the lower base member 20.

The swellings 13 of the upper deck 10 and the grooves 22 of the lower base member 20 may thus be formed as a positioning means or device for anchoring or positioning the upper deck 10 on top of the lower base member 20. However, it is to be noted that the lower base member 20 may alternatively include one or more swellings 13 extended therefrom for engaging into the corresponding grooves that are formed in the bottom portion 12 of the upper deck 10, such that the upper deck 10 may also be suitably anchored or positioned on top of the lower base member 20.

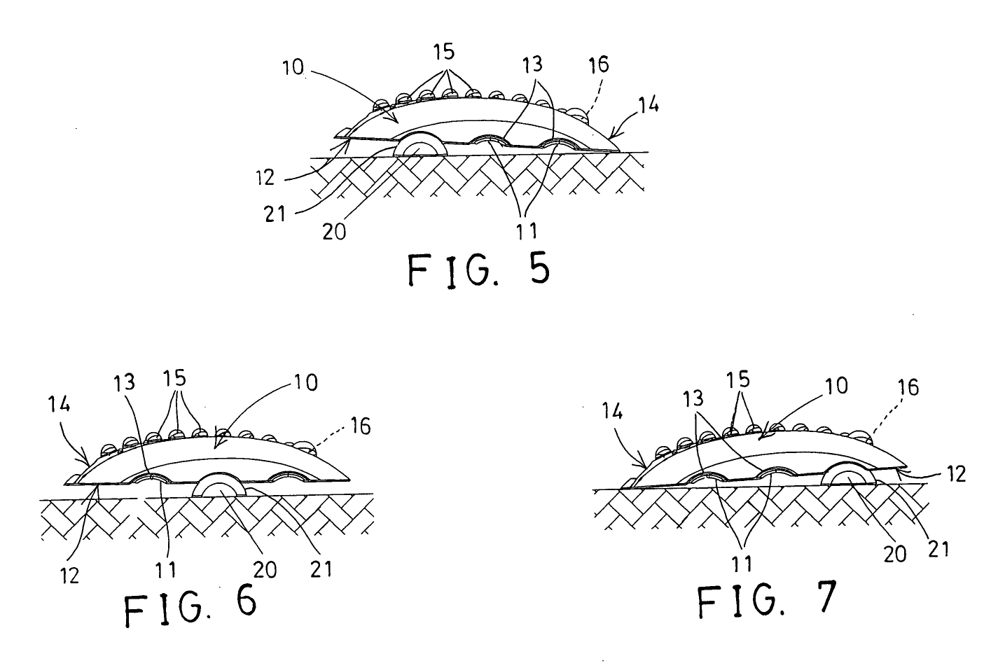

As best shown in FIGS. 5-7, the lower base member 20 may be engaged in either of the recesses 11 that is laterally formed in the bottom portion 12 of the upper deck 10, and includes a height greater than the depth of the recesses 11 of the upper deck 10, to allow the lower base member 20 to be extended downwardly beyond the bottom portion 12 of the upper deck 10, and thus to allow the upper deck 10 to be adjustably supported on the ground or the supporting surface at different inclinations or different angular directions.

Particularly, when the lower base member 20 is engaged in the middle or intermediate one of the recesses 11 of the upper deck 10, the upper deck 10 may also be supported and operated or actuated as a seesaw.

In operation, the users may have their feet portions, back portions, abdominal portions, neck portions, or even head portions, or other portions engaged onto the upper portion 14 and/or the protrusions 15 of the upper deck 10, to massage the various portions of the users. The magnets or magnetic members 16 may further be used for facilitating the blood circulation of the users.

Accordingly, the massage device in accordance with the present invention is adjustable to different inclinations relative to the ground or the supporting surface for suitably massaging various portions of the users, and includes a number of projections or protrusions of different sizes or volumes or areas, for suitably massaging various portions of the users.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A massage device comprising:
an upper deck including at least one recess formed in a bottom portion thereof, and including an upper portion having a plurality of protrusions extended upwardly therefrom, and
a lower base member including an upper portion partially engaged into said at least one recess of said upper deck, to support said upper deck relative to said lower base member at a selected inclination.

2. The massage device as claimed in claim 1, wherein said protrusions of said upper deck include different volume.

3. The massage device as claimed in claim 1, wherein said upper deck includes at least one magnetic member disposed in said protrusions.

4. The massage device as claimed in claim 1, wherein said upper deck includes a first end having a handle provided therein.

5. The massage device as claimed in claim 4, wherein said upper deck includes a second end having a width greater than that of said first end thereof.

6. The massage device as claimed in claim 1 further comprising means for anchoring said upper deck to said lower base member.

7. The massage device as claimed in claim 6, wherein said anchoring means includes at least one groove formed in said upper portion of said upper deck, and at least one swelling extended into said at least one recess of said lower base member, to anchor said upper deck to said lower base member.

8. The massage device as claimed in claim 1, wherein said at least one recess of said upper deck is located in a middle portion of said upper deck, to allow said upper deck to be supported on said lower base member as a seesaw.

9. The massage device as claimed in claim 1, wherein said upper deck further includes a second recess formed in said bottom portion thereof, for partially receiving said lower base member, to support said upper deck relative to said lower base member at different inclination.
